(19) United States
(12) Patent Application Publication
(10) Pub. No.: US 2017/0009140 A1
(43) Pub. Date: Jan. 12, 2017

(54) Method of Integrating Intumescent Infused Material to Form Fire Retardant Material

(71) Applicant: John H Canington, JR., Indian Land, SC (US)

(72) Inventor: John H Canington, JR., Indian Land, SC (US)

(21) Appl. No.: 15/274,516

(22) Filed: Sep. 23, 2016

Related U.S. Application Data
(63) Continuation-in-part of application No. 14/872,829, filed on Oct. 1, 2015.
(60) Provisional application No. 62/232,009, filed on Sep. 24, 2015.
(60) Provisional application No. 62/058,528, filed on Oct. 1, 2014.

(51) Int. Cl. C09K 21/14; C09K 21/04; C09K 21/02; C09K 21/10; C09K 21/06

(52) U.S. Cl. CPC C09K 21/14; C09K 21/10; C09K 21/06; C09K 21/02; C09K 21/04

(57) ABSTRACT

A method of integrating intumescent infused materials into solid material to form fire retardant material is completed with an intumescent powder mixture and any moldable material. The amount of intumescent powder mixture and the moldable material are proportionally and homogeneously mixed together to form a fire retardant material. A variety of levels of fire-resistance rating can be attained through the proportional mixing of the intumescent power mixture and the moldable material to create a final product. Thus, the final product expands with exposure to heat depending on the amount of intumescent powder mixture incorporated or impregnated into the final product.

The current application claims a priority to the U.S. Provisional Patent application Ser. No. 62/232,009 filed on Sep. 24, 2015.

### FIELD OF THE INVENTION

The present invention relates generally to a fire proof material. More specifically, the present invention is a method of integrating intumescent powder mixture to moldable material to form fire retardant material.

### BACKGROUND OF THE INVENTION

Fire retardant materials play a pivotal role in fire protection as fire retardant products or structures generally prevent or lessen the impact of fires. Typically, certain fixtures are covered with an intumescent coating in order to create fire retardant products.

The process of producing a fixture and then covering the fixture with an intumescent coating is costly and inefficient. Additionally, the limitations of intumescent coated products prevent the fire-proofing of most if not all products, thereby increasing the lives at risk.

It is an objective of the present invention to provide a method of integrating intumescent material to solid material to form fire retardant material/products. The present invention simplifies aforementioned infusion process as well as preserves and enhances the fire retardant qualities of products. The present invention is also able to provide different fire-resistance rating to products throughout the infusion process. The integrity of final products remains intact while providing fire proofing characteristics. The infusion process requires the mixing of the intumescent powder with the solid material. The preferred solid material is considered as plastic within the present invention; however other materials may include steel, foam, gypsum, or aluminum or any other material that may be heated and molded. The combination of the intumescent powder and the solid material is heated until intumescent powder is thoroughly and homogeneously mixed with the solid material to create final products from any types of molds as desired. Final products may include steel frames for a building structure, picture frames, security vaults, containers of all sizes and shapes, boxes, shingles, PVC pipes, and so on. Final products do not emit toxic fumes upon exposure to flames or intense heat as they do not comprise toxic chemicals.

### BRIEF DESCRIPTION OF THE DRAWINGS

FIG. 1 is a flow chart illustrating the overall process of the present invention.

FIG. 2 is a flow chart illustrating different moldable materials within the overall process of the present invention.

FIG. 3 is a flow chart illustrating the direct mixing between the intumescent powder mixture and the moldable material.

FIG. 4 is a flow chart illustrating the thermal impregnating between the intumescent powder mixture and the moldable material.

FIG. 5 is a flow chart illustrating the tensile strength testing and the fire retardant testing after the overall process of the present invention.

### DETAIL DESCRIPTIONS OF THE INVENTION

All illustrations of the drawings are for the purpose of describing selected versions of the present invention and are not intended to limit the scope of the present invention.

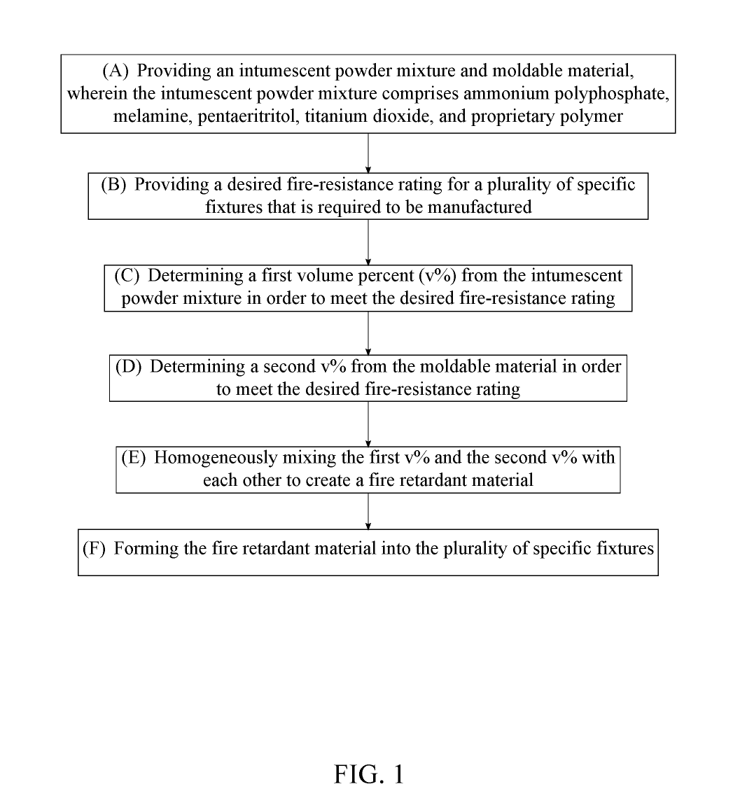

The present invention is a method of integrating intumescent infused material into solid material to form fire retardant material so that the fire retardant material can be melted or molded into different fixtures. The present invention can be implemented into a production line so that the different fire-resistance ratings can be integrated into different fixtures, wherein the present invention does not hinder the efficiency of the production line. In reference to FIG. 1, the present invention requires an intumescent powder mixture and moldable material to initiate manufacturing process of a plurality of specific fixtures. For example, the plurality of specific fixtures can include, but is not limited to, building structures, picture frames, security vaults, outlet covers, boxes, containers of all sizes and shapes, shingles, and PVC pipes. Additionally, the present invention also requires a desired fire-resistance rating for the plurality of specific fixtures as the desired fire-resistance rating can differ from one type of fixture to another. For example, security vaults may require higher fire-resistance rating in comparison to outlet covers as the security vaults require longer fire protection to protect valuable stored items and the outlet covers require shorter fire protection since they can be easily and cost-effectively replaced.

The intumescent powder mixture is a substance that swells as a result of heat exposure, thus increasing in volume and decreasing in density. The intumescent powder mixture achieves passive fire protection for the plurality of specific fixtures within the present invention and comprises ammonium polyphosphate, melamine, pentaeritritol, titanium dioxide, proprietary polymer, and other required ingredients. The proportions of each of the aforementioned ingredients are measured to reduce flammability of fuel or delay fuel combustion. More specifically, ammonium polyphosphate is an inorganic salt of polyphosphoric acid ammonia containing both chains and possibly branching. Ammonium polyphosphate is generally used as flame retardant in polymers and combined with starch-based materials pentaerythritol and melamine as expanding agent within the intumescent powder mixture. Melamine is an organic base trimer of cyanamide and mixed with resins to achieve fire retardant properties. Due to the resin mixture, the melamine releases nitrogen gas when it is burned or charred. Pentaerythritol is an organic compound and provides excellent resistance against ignition due to low volatility and high flash point. Titanium dioxide and proprietary polymer also function nonflammable materials within the intumescent powder mixture.

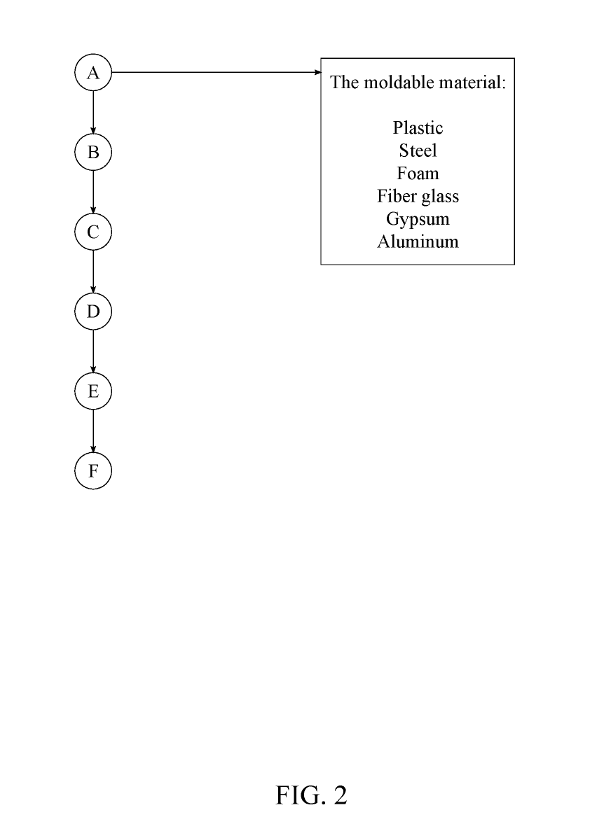

In reference to FIG. 2, the moldable material is the parent material as the intumescent powder mixture is added to the moldable material. More specifically, the moldable material can include, but is not limited to, plastic, steel, foam, fiber glass, gypsum, and aluminum. The moldable material is determined upon the plurality of specific fixtures as the moldable material can differ from one fixture to another. For example, outlet cover can have plastic as the moldable material while building structure can have gypsum or aluminum as the moldable material.

In reference to FIG. 1, the present invention first determines a first volume percent (v%) from the intumescent powder mixture so that the desired fire-resistance rating can be attained for the plurality of specific fixtures. Similarly, the present invention then determines a second v% from the moldable material in order to meet the desired fire-resistance rating for the plurality of specific fixtures. As a result, the first v% and the second v% are proportionally and collectively able to complete the specific fire-resistance within the present invention. For example, the first v% may comprise ten percent, twenty percent, thirty percent and so on of the intumescent powder mixture depending on the desired fire-resistance rating as the intumescent powder mixture limits the heat transfer process to the plurality of specific fixtures.

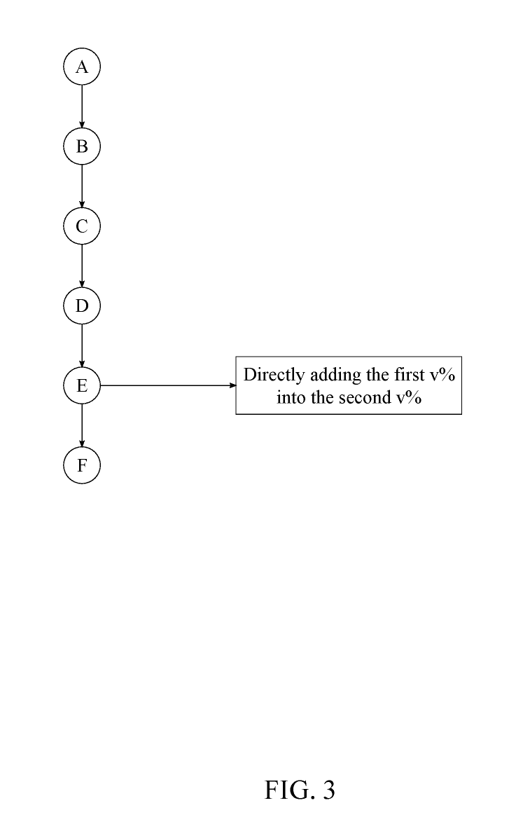

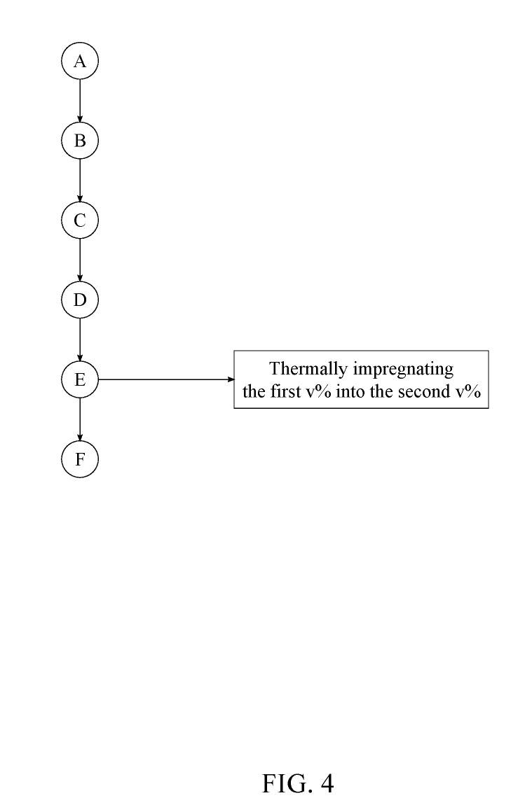

In reference to FIG. 1, the present invention then homogeneously mixes the first v% and second v% with each other to create a fire retardant material such that the plurality of specific fixtures is created. As illustrated in FIG. 1 and FIG. 3, the first v% can be directly added into the second v% during the homogeneously mixing process so that the plurality of specific fixtures can be molded with through the production line, wherein each specific fixture is formed with the fire retardant material. As illustrated in FIG. 1 and FIG. 4, the first v% can be thermally impregnated into the second v% during the homogeneously mixing process to create the fire retardant material. Then, the fire retardant material is melted and molded into the plurality of specific fixtures through the production line.

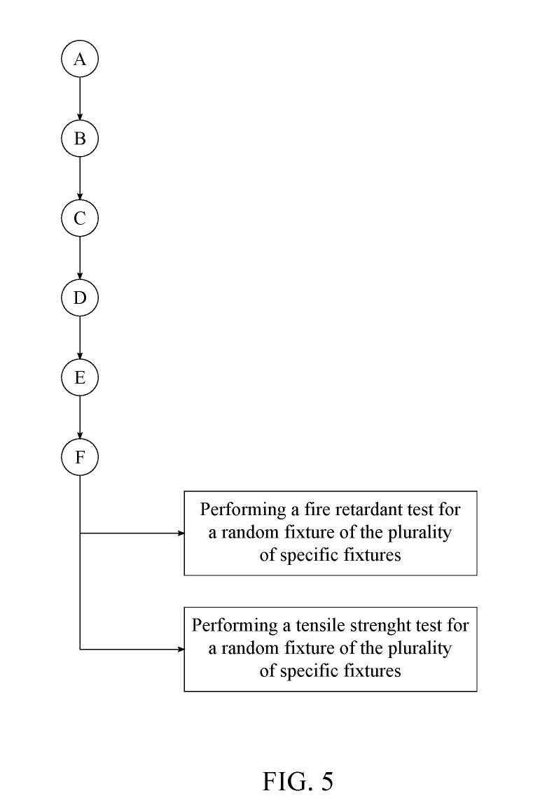

The plurality of specific fixtures comprises the necessary tensile strength and fire-resistance qualities as the proportional mixing of the intumescent powder mixture and the moldable material optimize the aforementioned qualities. However, the present invention performs additional testing to confirm the reliability of the plurality of specific fixtures in relation to extreme condition. More specifically, as illustrated in FIG. 5, the present invention performs a tensile strength test for a random fixture of the plurality of specific fixtures in order to ensure that the plurality of specific fixtures meets the required tensile strength. Additionally, the present invention performs a fire retardant test for the random fixture of the plurality of specific fixtures in order to ensure that the plurality of specific fixtures meets the required fire resistance qualities. Once the random fixture passes the tensile strength test and the fire retardant test, the present invention is able to approve the plurality of specific fixtures thus completing the manufacturing process.

Although the invention has been explained in relation to its preferred embodiment, it is to be understood that many other possible modifications and variations can be made without departing from the spirit and scope of the invention as hereinafter claimed.

What is claimed is:

1. A method of integrating intumescent infused materials into solid material to form fire retardant material comprises the steps of:
(A) Providing an intumescent powder mixture and moldable material, wherein the intumescent powder mixture comprises ammonium polyphosphate, melamine, pentaeritritol, titanium dioxide, and proprietary polymer;
(B) Providing a desired fire-resistance rating for a plurality of specific fixtures that is required to be manufactured;
(C) Determining a first volume percent (v%) from the intumescent powder mixture in order to meet the desired fire-resistance rating;
(D) Determining a second v% from the moldable material in order to meet the desired fire-resistance rating;
(E) Homogeneously mixing the first v% and the second v% with each other to create a fire retardant material; and
(F) Forming the fire retardant material into the plurality of specific fixtures.

2. The method of integrating intumescent infused materials to form fire retardant material as claimed in claim 1, wherein the moldable material being plastic.

3. The method of integrating intumescent infused materials to form fire retardant material as claimed in claim 1, wherein the moldable material being steel.

4. The method of integrating intumescent infused materials to form fire retardant material as claimed in claim 1, wherein the moldable material being foam.

5. The method of integrating intumescent infused materials to form fire retardant material as claimed in claim 1, wherein the moldable material being fiber glass.

6. The method of integrating intumescent infused materials to form fire retardant material as claimed in claim 1, wherein the moldable material being gypsum.

7. The method of integrating intumescent infused materials to form fire retardant material as claimed in claim 1, wherein the moldable material being aluminum.

8. The method of integrating intumescent infused materials to form fire retardant material as claimed in claim 1 comprises the step of:
directly adding the first v% into the second v% during step (E).

9. The method of integrating intumescent infused materials to form fire retardant material as claimed in claim 1 comprises the step of:
thermally impregnating the first v% into the second v% during step (E).

10. The method of integrating intumescent infused materials to form fire retardant material as claimed in claim 1, wherein a tensile strength test is performed for a random fixture of the plurality of specific fixtures after step (F).

11. The method of integrating intumescent infused materials to form fire retardant material as claimed in claim 1, wherein a fire retardant test is performed for a random fixture of the plurality of specific fixtures after step (F).
